(19) United States
(12) Patent Application Publication
(10) Pub. No.: US 2011/0079322 A1
(43) Pub. Date: Apr. 7, 2011

(54) FUEL FILLER SYSTEM

(75) Inventors: Robert Joseph Beier, Plymouth, MI (US); Brian Thomas Aitken, Livonia, MI (US); Michael Peter Ginster, Moenchengladbach (DE); John Ranger, Wickford (GB); Michael Wohlfahrter, Pulheim (DE); Rakesh Sandhu, Ilford (GB)

(73) Assignee: FORD GLOBAL TECHNOLOGIES, LLC, Dearborn, MI (US)

(21) Appl. No.: 12/574,811

(22) Filed: Oct. 7, 2009

(51) Int. Cl. B60K 15/04

(52) U.S. Cl. 141/350

(57) ABSTRACT

A capless fuel filler system has lower and upper sealing doors. The upper sealing door prevents water, water vapor, dust, etc. from entering into the space between the lower and upper doors. In prior systems with one sealing door a drain is provided to remove water (either directly entering or condensed water vapor), dust, or excess fuel drips from fueling just upstream of the lower door. By providing two sealing doors, water and dust cannot access the lower door. Although some fuel may puddle upstream of the lower door after a fueling event, the fuel is trapped, with no drain to the exterior, between lower and upper doors. If such fuel evaporates, it causes the lower door to open and vents the fuel vapors to the fuel tank, a desirable disposition for the vapors. The two sealing doors are contained in separate components to facilitate interchangeability and serviceability.

### BACKGROUND

1. Technical Field

The present development relates to a fuel filler assembly for an automotive vehicle.

2. Background Art

Capless fuel filler systems are known to provide a sealing door through which a fuel supply nozzle can be inserted for fueling purposes. The upstream side of the sealing door is subjected to ambient conditions. Water may splash up from the vehicle and collect at the upstream side of the sealing door. Also, water vapor may condense and collect near the sealing door. To prevent the collection of water and then entry of the water into the fuel tank during subsequent fueling, a drain is provided to drain away the fluid to a benign location.

It is also known that when fueling a vehicle some fuel drips off of the fuel filler nozzle when withdrawing the nozzle from the fuel filler system. In the prior art, this fuel collected on the upstream side of the sealing door is also drained away with the same drain.

It is desirable to eliminate the drain system from the fuel filler system for weight, cost, and complexity reasons. Furthermore, it is desirable to avoid draining away fuel drips, even though the quantity is a small fraction of the fuel delivered during fueling.

Another issue related to fuel filler pipes is to prevent misfueling. Fuel filler pipes on automotive vehicles are provided with an opening into which a fuel supply nozzle is inserted during refueling. Fuel filler pipes are sized to coordinate with the fuel supply nozzle. It is known, for example, that a diesel fuel supply nozzle is greater in diameter than a gasoline fuel supply nozzle. To prevent misfueling of, for example, a gasoline-fueled vehicle, the vehicle's fuel filler neck is smaller than the diesel fuel supply nozzle, thereby preventing putting diesel fuel in a gasoline tank. However, the reverse is not prevented by this measure alone.

There are no international standards on fuel supply nozzles. Thus, even within certain countries, the fuel supply nozzle diameter used for a particular kind of fuel varies from region to region. On a global basis, fuel supply nozzle diameter depends on both the type of fuel being dispensed and the geographic region, thereby further complicating the issue of misfueling.

It is known in the art to overcome the misfueling problem by installing a misfueling inhibitor (MFI) in the fuel filler pipe assembly. One type of MFI has an aperture of a diameter which prevents entry of a fuel supply nozzle with too great a diameter. The MFI also has two or more latches arranged near a flapper door, the latches facing toward the opening. Walls of a fuel supply nozzle having a diameter in an appropriate range can depress all of the latches thereby allowing the door to open and fuel to be dispensed. A fuel supply nozzle of a smaller diameter engages fewer than all the latches at a time thereby preventing the flapper door from opening. Another type of MFI has an upper portion which blocks nozzles of too large a diameter. After making it through the upper portion, the nozzle encounters a ring with a slot removed, which is connected to a latching mechanism on a flapper door. A nozzle which is too small easily slides through the ring without unlatching the door. However, a large enough nozzle spreads the ring apart thereby unlatching the door allowing the nozzle to be inserted all the way through the MFI. In these non-limiting examples, only a fuel supply nozzle of the appropriate diameter, or small range in diameter, can both enter the MFI and actuate the latch(es) on the flapper door on the MFI.

An automotive manufacturer with global customers wishing to prevent misfueling is obligated to provide a wide variety of fuel filler pipes with a range of MFIs for global supply. If a vehicle intended for a particular region has a fuel filler assembly with a MFI for that region is then transferred to another region requiring a different MFI than was installed, the entire fuel filler assembly need be replaced.

### SUMMARY

To solve at least one problem in the prior art, a fuel fill assembly adapted to be installed into a fuel fill pipe of an automotive vehicle is disclosed which has an upper piece including an upper selectively-openable closure and a lower piece including a lower selectively-openable closure. The upper piece releasably couples with the lower piece. The upper closure includes: an upper seal, a frame defining an upper port adapted to accept a fuel supply nozzle, an upper flapper door coupled to the frame by a hinge with the upper seal set into a groove in the upper flapper door, and a spring coupled between the upper flapper door and the frame. The spring urges the upper flapper door to a closed position with a force to cause the upper seal to deform against the frame. In an alternative embodiment, the upper seal is set into a groove in the frame.

The lower closure includes: a frame defining a lower port, the lower port adapted to accept a fuel supply nozzle, a lower flapper door coupled to the frame by a hinge; and a seal set into a frame groove in the frame or a door groove in the upper flapper door, and a spring coupled between the lower flapper door and the frame. The spring urges the lower flapper door to a closed position with a force sufficient to deform the seal between the lower flapper door and the frame.

The upper piece and lower piece are releasably coupled using a threaded connection, a bayonet coupler, a slot-and-tab coupler, a twist lock coupler, or any known removable coupling system can be employed.

The fuel fill assembly, in one embodiment, is installed into an automotive vehicle having a fuel fill pipe. The fuel fill assembly includes a sealing member fitted onto an external surface of the lower piece. The sealing member, made of a resilient material, seals between an exterior surface of the lower piece and an interior surface of the fuel fill pipe. The lower piece may also include a fuel guide coupled downstream end of the lower piece. A fuel guide is optional depending on the geometry of the fuel fill pipe and the fuel dispensing systems provided in the region in which the vehicle is refueled. In other embodiments, the fuel fill assembly has valves to provide pressure and vacuum relief to the fuel system depending on the application. In some applications, vacuum relief can be achieved through the upper and lower sealing doors; thus, no pressure or vacuum relief is added. However, for pressure and lower vacuum relief, additional valves are included in the full assembly depending on system requirements in various markets.

Also disclosed is a fuel fill assembly adapted to be installed into a fuel fill pipe of an automotive vehicle having upper and lower pieces. The upper piece includes: an upper frame defining an upper aperture adapted to accept a fuel supply nozzle, an upper articulating door coupled to the upper frame by an upper hinge, an upper spring coupled between the upper frame and the upper articulating door, and an upper seal between the upper articulating door and the upper frame. The lower piece includes: a lower frame defining a lower aperture adapted to accept the fuel supply nozzle, a lower articulating door coupled to the lower frame by a lower hinge, a lower spring coupled between the lower frame and the lower articulating door, and a lower seal between the lower articulating door and the lower frame. The lower and upper springs bias the lower and upper articulating doors to cover the lower and upper apertures, respectively. The lower and upper seals are deformed by force exerted by the lower and upper springs, respectively.

The seals are located in a door groove or a frame groove. In one embodiment, the upper piece also includes a misfuel inhibitor located between the lower and upper articulating doors. The misfuel inhibitor prevents insertion of a fuel supply nozzle having a diameter that is outside of predetermined range. In another embodiment, the misfuel inhibitor is integrated with the upper articulating door. The misfuel inhibitor prevents opening of the upper articulating door by fuel supply nozzles having a diameter greater than an upper limit diameter and fuel supply nozzles having a diameter less than or equal to a lower limit diameter. In yet another alternative, the lower piece further has a misfuel inhibitor. Alternatively, the misfuel inhibitor is integrated with the lower articulating door to prevent opening of the lower articulating door by fuel supply nozzles having a diameter greater than an upper limit diameter and fuel supply nozzles having a diameter less than a lower limit diameter.

As installed in an automotive vehicle having a fuel tank, the lower and upper articulating doors swing toward the fuel tank when opened. Pressure buildup in a space in between the lower and upper articulating doors exerts a closing force on the upper articulating door and an opening force on the lower articulating door.

In one embodiment, the fuel fill assembly is installed into an automotive vehicle having a fuel fill pipe with a sealing member set into a circumferential groove in an external surface of the lower piece. The sealing member forms a seal between an exterior surface of the lower piece and an interior surface of the fuel fill pipe.

Some prior art systems provide two doors in a fuel assembly with only a lower door having a seal. Such system largely prevents water from splashing into the space in between the two doors. However, it doesn't prevent water vapor from entering the upper door and condensing in the space between the two doors or from fuel vapors trapped between the two doors from vaporizing and exiting out the non-sealing upper door. Thus, such prior art systems are typically supplied with drains to remove water buildup. By providing two sealing doors, according to an embodiment of the present disclosure, water vapor and water are prevented from entering through the upper door obviating the need for a drain thereby reducing complexity, weight, and cost.

Another advantage is that any excess fuel dripping off a fuel supply nozzle after a fueling operation is trapped between lower and upper doors. Because the doors both open inward, any pressure increase due to vaporization of the trapped fuel causes the upper door to be sealed with a greater force and cause the lower door to open, if the pressure due to vaporization is sufficient to act against the spring force. When the lower door opens, fuel vapors are introduced into the tank and its associated fuel vapor recovery system. Consequently, emission of such fuel vapors into the atmosphere is avoided.

An advantage of the present invention is that the vehicle can travel through the assembly process with only the lower piece of the fuel assembly attached. Because the lower piece has a flapper door, debris is prevented from entering the fuel tank. But, fuel can be supplied to the vehicle through the flapper door.

Yet another advantage of the present development is that if the upper piece of the fuel assembly needs to be replaced, for example by virtue of damage caused, for example, by vandalism or by the vehicle owner moving among regions with different fuel supply nozzle diameters, the entire fuel filler system need not be replaced. Instead, the existing upper piece of the fuel filler assembly can be decoupled from the lower piece and an appropriate replacement upper piece is coupled with the lower piece. In embodiments in which the lower and upper pieces can be decoupled nondestructibly, the replacement can be accomplished with minimal effort and cost and with minimal risk of destruction to the system and/or vehicle. In another embodiment, the upper piece is destroyed in the process of removal to avoid the possibility that it could be installed onto another vehicle for which it is not intended. In such an embodiment, the lower piece is unharmed in the process so that it can couple with a replacement upper piece of the appropriate specification for the region in which its operation is intended.

### BRIEF DESCRIPTION OF THE DRAWINGS

FIG. 1 shows a portion of a vehicle with a fuel tank;

FIG. 2 shows a fuel fill assembly according to an embodiment of the disclosure;

FIG. 3 shows a misfuel inhibitor according to the prior art;

FIG. 4A shows a flapper door with a groove according to an embodiment of the present disclosure;

FIG. 4B shows a cross section of the flapper door of FIG. 4A;

FIG. 4C shows a cross section of the flapper door cooperating with a frame;

FIG. 5A shows a flapper door according to an embodiment of the present disclosure;

FIG. 5B shows a cross section of the flapper door of FIG. 5A cooperating with a frame with a groove;

FIGS. 6 and 7 show a portion of a lower piece according to an embodiment of the present disclosure;

FIG. 8 shows a portion of an upper piece adapted to engage with lower piece of FIG. 7 according to an embodiment of the present disclosure; and

FIG. 9 is a cross section of lower piece of FIG. 7.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to a capless fuel fill assembly for an automotive vehicle. However, the fuel fill assembly may be incorporated into various other types of vehicles, such as boats, private airplanes, etc. Those of ordinary skill in the art may recognize similar applications or implementations whether or not explicitly described or illustrated.

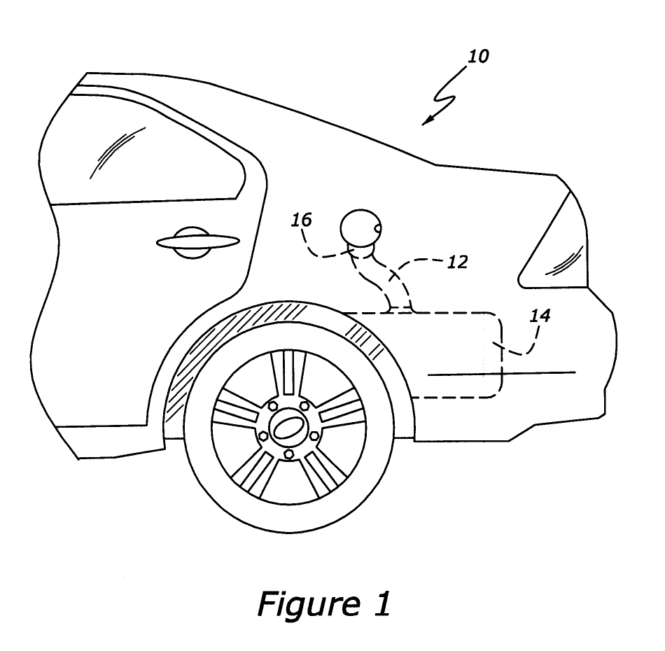

In FIG. 1, a portion of an automotive vehicle 10 is shown which has a fuel fill pipe 12 leading to a fuel tank 14. Inside the fuel fill pipe 12 is a fuel assembly 16.

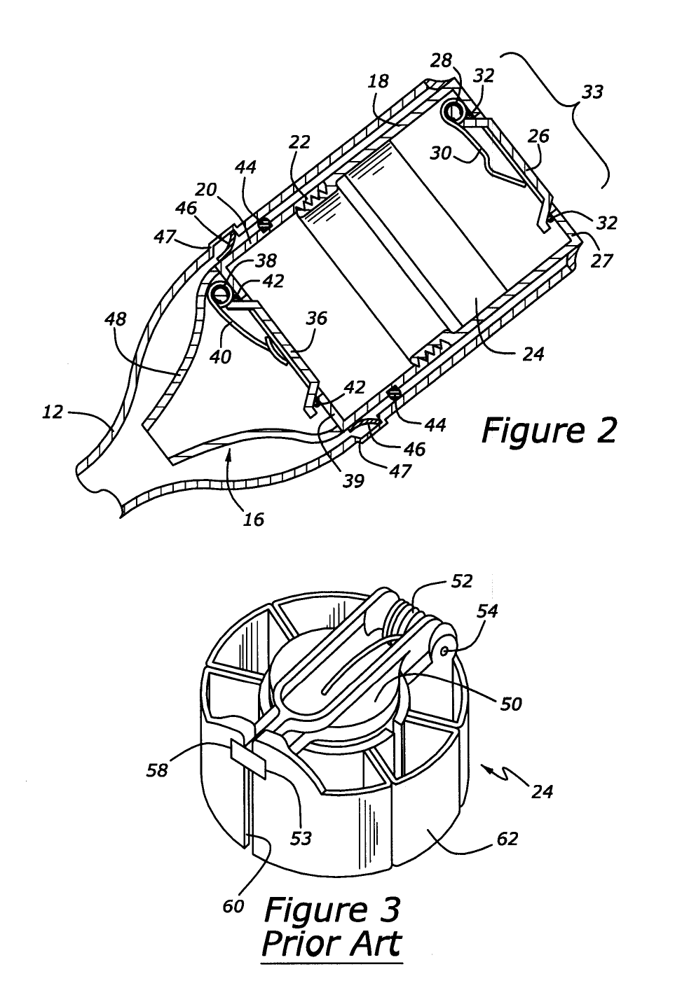

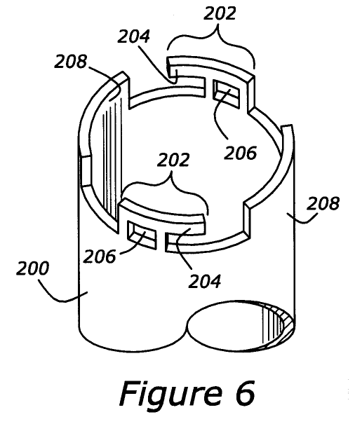

FIG. 2 is a cross-sectional representation of fuel fill pipe 12 and the fuel fill assembly. The fuel fill assembly 16 includes an upper piece 18 and a lower piece 20, which are releasably coupled together. That is, upper piece 18 can be decoupled from lower piece 20 while lower piece 20 remains installed within fuel fill pipe 12. In FIG. 1, upper piece 18 and lower piece 20 are coupled together via a threaded connection 22. Upper piece 18 and lower piece 20 seal at connection 22. By a suitable selection of thread type, the threads can provide the desired seal. Alternatively, a resilient seal is provided at the connection between the two pieces. While a threaded connection is shown in FIG. 2, any suitable other connection alternative, can be used, in place of threads. For example, a tab-and-slot connection is provided between upper piece 18 and lower piece 20, which is discussed in regards to FIGS. 6-9.

Within upper piece 18, a misfuel inhibitor 24 is installed. Misfuel inhibitor 24 is discussed below in more detail in relation to FIG. 3. In the embodiment shown in FIG. 2, upper piece 18 has an upper flapper door 26 located on the upstream end of upper piece 18 mating with a frame 27, with flapper door 26 covering an upper port, or aperture, defined in frame 27. Upper flapper door 26 has a hinge 28 about which upper flapper door 26 rotates to open. Upper flapper door 26 is biased toward a closed position by spring 30. Upper flapper door 26 is also equipped with a seal 32, shown as an 0-ring in the embodiment in FIG. 2. Although upper piece 18 is shown in FIG. 2 as having a misfuel inhibitor 24, in some alternative embodiments, misfuel inhibitor 24 is integrated into an upper selectively-openable closure 33. In other embodiments, misfuel inhibitor 24 is included in lower piece 20. Or, in other embodiments, no misfuel inhibitor is installed. Upper selectively-openable closure 33, in one embodiment, is an assembly including: door 26, frame 27, hinge 28, spring 30, and seal 32.

Continuing to refer to FIG. 2, lower piece 20 contains a lower flapper door 36 which rotates about a hinge 38. As shown in FIG. 2, flapper door 36 is biased to a closed position in which flapper door 36 abuts frame 39. Flapper door 36 is biased towards frame 39 by spring 40. A lower port, or aperture, is defined in frame 39; the port is covered by flapper door 36, as shown in FIG. 2. Seal 42 is deformed under force applied to door 36 by spring 40 to provide sealing. Seal 42 is shown as an 0-ring in FIG. 2; but such example is not intended to be limiting; other seal types are also contemplated. Fuel fill pipe 12 is coupled to fuel tank 14 (not shown in FIG. 2). To prevent fuel tank vapors from being released from the vehicle by passing through the space between fuel fill pipe 12 and fuel assembly 16, a sealing member 44 is placed between lower piece 20 and fuel fill pipe 12 and set into a groove 43 on lower piece 20. In an alternative embodiment, a groove (not shown) is formed in fuel fill pipe 12 and sealing member 44 is placed in the groove in fuel fill pipe 12. An additional seal, similar to sealing member 44, can be positioned or placed at the top of pipe interfacing with upper piece 18 and frame 27 to substantially completely seal the inner diameter of fuel fill pipe 12 to protect against the intrusion of dust, dirt, debris water or any other corrosive elements. In some embodiments, tabs 46 are on the upper surface of lower piece 20. As lower piece 20 is installed into fuel fill pipe 12, tabs 46 are bend inwards and ride on the inside surface of fuel fill pipe 12. When lower piece 20 is at its installed position, tabs 46 snap into slots 47 to secure lower piece 20 within fuel pipe 12. Lower piece 20 is coupled to a flow guide 48, which directs the fuel into fuel fill pipe 12 in such a way to substantially prevent backsplash. The guide is desirable where, due to geometry of the filler system on the vehicle or poor dispensing flow quality, backsplash is more prevalent.

Any suitable misfuel inhibitor 24 can be employed.

FIG. 3 shows an exemplary misfuel inhibitor 24 as seen from a downstream side, i.e., with the door opening outward. Various misfuel inhibitor 24 designs are known, such as those shown in US 2008/0237230 A1 and WO 2008/127916 A1, which are incorporated by reference in their entirety. Misfuel inhibitor 24 has a flapper door 50, which is biased by coil spring 52 and rotates about bearing pin 54. Across from pin 54, flapper door 50 has a projection 53 which latches into notches 58 emanating from slot 60 of ring 62. As shown in FIG. 3 in which ring 62 is undisturbed, projection 53 prevents flapper door 50 from rotating open. However, when a cylindrical object, such as a fuel supply nozzle, of an appropriate diameter is inserted into misfuel inhibitor 24 (through the end not shown in FIG. 3), the object causes ring 62 to spread apart along slot 60 allowing projection 53 to be released from notches 58 thereby allowing the flapper door 50 to open. Projection 53 and ring 62 with notches 58 provide a non-limiting example of a latching device that can be included in a misfuel inhibitor 24.

As described above, misfuel inhibitor 24 can be integrated into upper selectively openable closure 33. Alternatively, misfuel inhibitor 24 can be integrated into lower selectively openable closure (includes door 36, spring 40, hinge 38, seal 42, and frame 39).

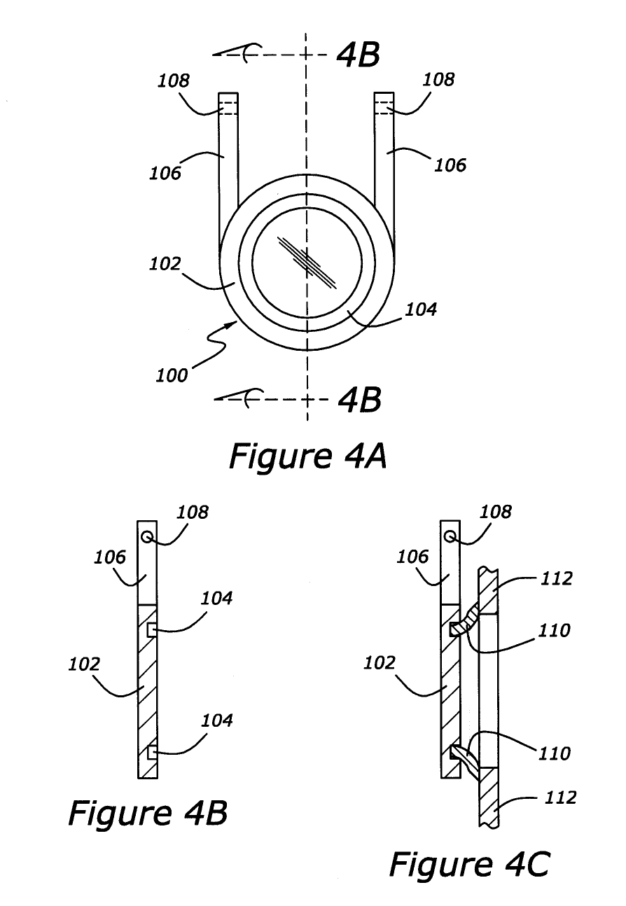

In FIG. 4A, a flapper door 100 is shown which has a plate 102 with a groove 104 into which a seal can be placed, molded or manufactured. Flapper door 100 may represent either one or both of doors 26 and 36. Flapper door 100 has arms with holes 108 through which a pin can be inserted, for flapper door 100 to rotate about to open and close off a fuel filler port. A cross section of plate 102 with groove 104 is shown in FIG. 4B. In FIG. 4C, a cross section of plate 102 is shown with the groove having a seal 110 inserted. Seal 110 is overmolded into the groove or provided by any known process. Seal 110 in FIG. 4C is shown proximate frame 112, also shown in cross section. Frame 112 has a port defined therein. Plate 102 of flapper door 100 cooperates with frame 112, in particular, a spring force (spring not shown) biasing plate 102 toward frame 112 causes seal 110 to deform to seal between the two sides of plate 102. The cooperation of seal 110 with frame 112 seals off the port defined in frame 112.

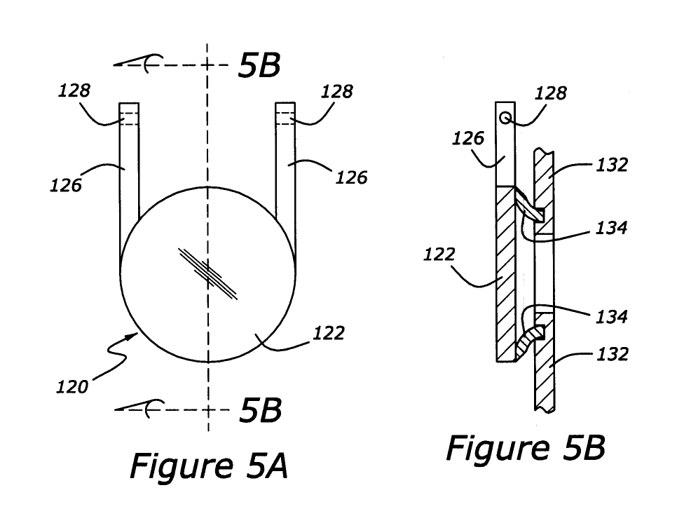

Alternatively, the seal is applied to the frame as shown in FIGS. 5A and 5B. A flapper door 120 has a plate 122 with arms 126 and holes 128 to accommodate a pin about which flapper door 120 can rotate. A spring (not shown) can be associated with the pin and flapper door 120 to cause flapper door 120 to be biased toward a closed position. A cross section of plate 122 is shown in FIG. 5B proximate to a frame 132 which has a port defined therein. Frame 132 has grooves in which seal 134 is affixed. Seal 134 can be overmolded onto frame 132; alternatively, any other process known to one skilled in the art can be used. Due to spring force, seal 134 is deformed against plate 122 to seal between the two sides of plate 122. Frame 132 may represent either frame or both frames 27 39.

In FIG. 6, one inner piece 200 of a tab and slot coupler is shown. There are engagement features 202 which each have an installation guide 204 and an orifice 206. Indexing features 208 are included to aid in indexing engagement features 202 properly during installation.

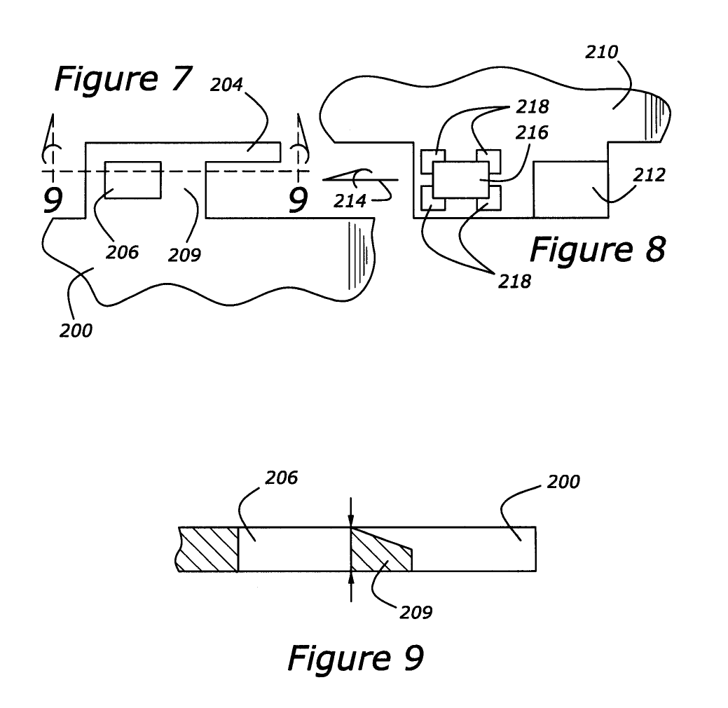

A portion of the circumference of lower piece 200 is shown in FIG. 7. The piece is shown flat for the purposes of illustrating the coupling joint. In FIG. 7, there is a ramp portion 209. The ramp cannot be seen from this view, but will become apparent in regards to FIG. 9. FIG. 8 shows a portion of an upper piece 210. It has a raised portion 212, which couples with installation guide 204 when moved in the direction of arrow 214. A raised button 216 is partially surrounded by break out orifices 218. As shown, raised button 216 is connected to upper piece 200 on about one-third of the periphery and is contiguous to orifices 218 for about two-thirds of the periphery.

In FIG. 9, a cross-section of lower piece 200 is shown. Orifice 206 is visible. The ramp of ramp portion 209 can be seen from the view in FIG. 9. During assembly, upper piece 210 moves relative to lower piece 200, as illustrated by arrow 214 in FIG. 8. Button 218 rides on ramp 209 until it falls into orifice 206. Lower piece 200 and upper piece 210 flex as button 218 rides over ramp 209 during assembly. Upon disassembly, however, button 218 is held in place by the thick section, t, of ramp 209. Button 216 is torn out of lower piece 200 during disassembly. Orifices 218 allow some flex of button 216 within lower piece 200 during assembly to negotiate ramp 209. However, orifices 218 weaken the connection between button 216 with upper piece 210 such that button 216 rips out upon removal. This ensures that upper piece 210 is not reused in an improper application.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

What is claimed:

1. A fuel fill assembly adapted to be installed into a fuel fill pipe of an automotive vehicle, the fuel fill assembly comprising:
an upper piece including an upper selectively-openable closure; and
a lower piece including a lower selectively-openable closure wherein the upper piece sealingly couples with the lower piece and the upper closure comprises an upper seal.

2. The fuel fill assembly of claim 1 wherein the upper closure comprises:
a frame defining an upper port, the upper port adapted to accept a fuel supply nozzle;
an upper flapper door coupled to the frame by a hinge wherein the upper seal is set into a groove in the upper flapper door; and
a spring coupled between the upper flapper door and the frame, the spring urging the upper flapper door to a closed position with a force to cause the upper seal to deform against the frame.

3. The fuel fill assembly of claim 2 wherein the fuel fill pipe is coupled to a fuel tank and the upper flapper door opens towards the fuel tank.

4. The fuel fill assembly of claim 1 wherein the upper closure comprises:
a frame defining an upper port, the upper port adapted to accept a fuel supply nozzle;
a seal set into a groove in the frame;
an upper flapper door coupled to the frame by a hinge; and
a spring coupled between the upper flapper door and the frame, the spring urging the upper flapper door to a closed position with a force to cause the upper seal to deform against the upper flapper door.

5. The fuel fill assembly of claim 1 wherein the lower closure comprises:
a frame defining a lower port, the lower port adapted to accept a fuel supply nozzle;
an upper flapper door coupled to the frame by a hinge; and
a seal set into one of a frame groove in the frame and a door groove in the upper flapper door; and
a spring coupled between the lower flapper door and the frame, the spring urging the lower flapper door to a closed position with a force sufficient to deform the seal between the lower flapper door and the frame.

6. The fuel fill assembly of claim 1 wherein the upper piece and lower piece are releasably coupled via one of a threaded connection, a bayonet coupler, a slot and tab coupler, and a twist lock coupler.

7. The fuel fill assembly of claim 1 wherein the fuel fill assembly is installed into an automotive vehicle having a fuel fill pipe, the fuel fill assembly further comprising: a sealing member fitted onto an external surface of the lower piece, such sealing member forming a seal between an exterior surface of the lower piece and an interior surface of the fuel fill pipe.

8. The fuel fill assembly of claim 1 wherein the lower piece further includes a fuel guide on a downstream end of the lower piece.

9. The fuel fill assembly of claim 6, further comprising: a seal provided on one of the upper and lower pieces at the coupling location.

10. The fuel fill assembly of claim 6, further comprising: a tab on the lower piece adapted to breakaway when the upper and lower pieces are decoupled.

11. A fuel fill assembly adapted to be installed into a fuel fill pipe of an automotive vehicle, the fuel fill assembly comprising:
an upper piece comprising:
an upper frame defining an upper aperture adapted to accept a fuel supply nozzle;
an upper articulating door coupled to the upper frame by an upper hinge;
an upper spring coupled between the upper frame and the upper articulating door, the upper spring urging the upper articulating door to cover the upper aperture; and
an upper seal between the upper articulating door and the upper frame, the upper seal being deformed by force exerted by the upper spring against the upper articulating door; and
a lower piece comprising:
a lower frame defining a lower aperture adapted to accept the fuel supply nozzle;
a lower articulating door coupled to the lower frame by a lower hinge;
a lower spring coupled between the lower frame and the lower articulating door, the lower spring urging the lower articulating door to cover the lower aperture; and
a lower seal between the lower articulating door and the lower frame, the lower seal being deformed by force exerted by the lower spring against the lower articulating door.

12. The fuel fill assembly of claim 11 wherein the upper seal is located in one of a door groove in the upper articulating door and a frame groove in the upper frame.

13. The fuel fill assembly of claim 11 wherein the lower seal is located in one of a door groove in the lower articulating door and a frame groove in the lower frame.

14. The fuel fill assembly of claim 11 wherein the upper piece further comprises a misfuel inhibitor which is coupled to the upper articulating door, the misfuel inhibitor preventing opening of the upper articulating door by fuel supply nozzles having a diameter greater than an upper limit diameter and fuel supply nozzles having a diameter less than a lower limit diameter.

15. The fuel fill assembly of claim 11 wherein the lower piece further comprises a misfuel inhibitor which is coupled to the lower articulating door, the misfuel inhibitor preventing opening of the lower articulating door by fuel supply nozzles having a diameter greater than an upper limit diameter and fuel supply nozzles having a diameter less than a lower limit diameter.

16. The fuel fill assembly of claim 11 wherein the fuel fill assembly is installed into an automotive vehicle having a fuel fill pipe and a fuel tank coupled to the fuel fill pipe, wherein:
the lower and upper articulating doors swing toward the fuel tank when opened;
liquid located in a space in between the upper articulating door and the lower articulating door remains trapped in the space; and
a pressure buildup in the space exerts a closing force on the upper articulating door and an opening force on the lower articulating door to relieve pressure into the fuel tank.

17. The fuel fill assembly of claim 11 wherein the fuel fill assembly is installed into an automotive vehicle having a fuel fill pipe, the fuel fill assembly further comprising: a sealing member set into a circumferential groove in an external surface of the lower piece, such sealing member forming a seal between an exterior surface of the lower piece and an interior surface of the fuel fill pipe.

18. A capless fuel closure adapted to be releasably coupled to a lower piece installed into a fuel fill pipe of an automotive vehicle, the capless fuel closure comprising:
a tube having an upper end and a lower end;
a frame defining an aperture, the frame being disposed on the upper end of the tube;
a selectively articulating door coupled to the frame by a hinge;
a spring coupled between the frame and the articulating door, the spring urging the articulating door to cover the aperture, and the articulating door adapted to open by insertion of a fuel supply nozzle;
a seal between the articulating door and the frame, the seal being deformed by force exerted by the spring against the articulating door; and
a releasable coupler formed in the lower end.

19. The capless fuel closure of claim 18 wherein under deformation of the seal by the spring, fuel vapor, water, water vapor, and dust are substantially prevented from traveling from one side of the articulating door to the other side of the articulating door.

20. The capless fuel closure of claim 18 wherein the articulating door opens toward a vehicle fuel tank when installed in a vehicle.
